(19) United States
(12) Patent Application Publication
(10) Pub. No.: US 2008/0305208 A1
(43) Pub. Date: Dec. 11, 2008

(54) Dairy Ingredient - Preparation and Use

(75) Inventors: Skelte Gerald Anema, Palmerston North (NZ); Siew Kim Lee, Palmerston North (NZ)

Correspondence Address: KNOBBE MARTENS OLSON & BEAR LLP, 2040 MAIN STREET, FOURTEENTH FLOOR, IRVINE, CA, 92614, US

(73) Assignee: FONTERRA CO-OPERATIVE GROUP, Auckland (NZ)

(21) Appl. No.: 11/722,687

(22) PCT Filed: Dec. 24, 2004
(86) PCT No.: PCT/NZ2004/000335

§ 371 Date: Jun. 19, 2008

(51) Int. Cl. A23C 19/00; A23J 3/08; A23C 9/12

(52) U.S. Cl. 426/39; 426/582; 426/573

(57) ABSTRACT

The invention provides a method for producing a dairy powder or a dairy concentrate. The pH of a liquid dairy starting material comprising casein and whey proteins is adjusted if necessary by addition of acid or alkali to a pH in the range 5.0-8.0. The pH adjusted material is then heat-treated to denature whey protein in the presence of casein. This treated material is either retained or dried to form a powder or as a dairy concentrate. The product may be used in a method for forming a product such as a processed cheese, a processed cheese-like product, a spread, a yoghurt or a dairy dessert. In this method, the product is dissolved/suspended (if necessary) and undergoes pH adjustment to a pH in the range 4.5-6.5. The material may be cooked to form a molten mass which is subsequently cooled to form a milk protein gel.

### TECHNICAL FIELD

The present invention relates to a dried milk protein concentrate or to a dairy concentrate.

### BACKGROUND

The applicant in copending application PCT/NZ2004/000142 has demonstrated a means of modifying the texture of milk protein gels, including processed cheese (PC) and PC-like products, spreads, yoghurts and desserts, by the manipulation of pH during the cooking phase in the PC kettle. However the manipulation of pH during the PC cooking operation is inconvenient. Processors want to avoid added complexity and the risk of variability, especially in a batch process with a rapid turn-round time.

The efficiency of the overall process (converting milk ultimately into PC) could be improved significantly, if the benefits of the texture enhancement in the PC could be pre-built into the protein ingredient(s) used to produce the eventual product.

Bhaskar et al. (WO 2004057971) disclose a process for enhancing cheese yield by the heat treatment of a calcium depleted MPC. An optional pH adjustment may be conducted prior to heat treatment, evaporation and drying, and the disclosure states; ‘Once the MPC or MPI has passed through the column, its pH increases. If it increases above 7.0, it will generally be adjusted to about 6.5-7.0 to make it more palatable’. This process does not teach of any texture benefit in PC arising from the heat treatment or pH adjustment in non-calcium depleted MPCs.

Bhaskar et al. further note, ‘Cheese prepared by the methods of the invention may be further processed to prepare processed cheese or a processed cheese type product’. There is no teaching that the ingredient prepared according to WO 2004057971 can be usefully used directly in PC manufacture to modify the PC texture.

Anema, Lowe and Lee, in (Effect of pH at heating on the acid-induced aggregation of casein micelles in reconstituted skim milk, Lebensm.-Wiss.u-Technol. 2004, 37, 779-787) disclose that the rheology of milk may be varied by heat treatment at controlled pHs between 6.0-7.0. They report however, ‘It should be noted that this investigation measured only the pH at which aggregation commenced. This is no indication of the properties of the acid gels that are formed when the final gel is set.’ Consequently, there is no teaching of how the texture of PC (essentially an acidic fat-containing gel of pH about 5.6) may be manipulated using an ingredient prepared from a dairy stream that is treated by the process disclosed in this invention.

Anema et al., in Rheological properties of acid gels prepared from heated pH-adjusted skim milk. J. Agric. Food Chem. 2004, 52, 337-343 showed further that the rheological behaviour of skim milk may be manipulated using heat treatments at controlled pHs between 6.0-7.0. The pH adjusted and heat treated skim milk was then re-adjusted back to a pH of 6.7 and then treated with 2% w/w glucono-δ-lactone (GDL). This publication does not teach the preparation of a dried ingredient, the advantages of avoiding the adjustment to pH 6.7 or the consequences of not using GDL.

It is an object of the invention to provide a dry ingredient or a concentrate for use in preparing a milk protein gel having a modified texture and/or to provide a method for preparing the milk protein gels and/or to provide the public with a useful choice.

### DISCLOSURE OF THE INVENTION

This invention discloses a method of altering the texture of milk protein gels, including PC and PC-like products, spreads, yoghurt and desserts by the use of an ingredient prepared as a dairy concentrate and the manipulation of the concentrate's pH and heat treatment.

Unlike the manufacture of PC, which typically operates as a short run batch operation, the manufacture of protein products such as milk protein concentrates (MPCs), and the like, are made using long production runs, thereby giving the possibility of long controlled conditions to manipulate the pH and heat treatment conditions. Surprisingly the applicants have found that the controlled pH-heat treatment of the protein ingredient, prior to drying, results in a product that when it is eventually reconstituted and used in the PC cooker (kettle), confers a modified texture to the PC product. Preferably the pH adjustment and heat treatment steps are performed after concentration of the protein stream and immediately prior to drying (preferably spray drying).

In one aspect the invention provides a method for producing a dairy powder comprising:
(a) providing liquid dairy starting material comprising casein and whey proteins;
(b) adjusting if necessary the pH by addition of acid or alkali to a pH in the range 5.0-8.0;
(c) heat-treating the pH adjusted material to denature whey protein in the presence of casein; and
(d) drying the heat-treated material to form a powder.

The invention also provides a powder prepared by the method.

In a further aspect the invention provides a method for producing a dairy concentrate comprising:

(a) providing liquid dairy starting material comprising casein and whey proteins;

(b) concentrating the material if necessary to give a solids not fat content of greater than 10% (w/v);

(c) adjusting if necessary the pH by addition of acid or alkali to a pH in the range 5.0-8.0;

(d) heat-treating the pH adjusted material to denature whey protein in the presence of casein; and

(e) cooling the heat-treated material and storing it in one or more storage vessels;

wherein step (b) may be carried out before, during or after step (c).

The invention also provides a dairy concentrate prepared by that method.

The invention applies to any dairy stream (either high or low in fat) that contains both un-denatured (native) whey proteins and casein. The ratio of whey protein relative to the casein may be that which arises naturally in milk, or the ratio may be adjusted by for instance the depletion of whey protein or enhanced by the addition of native whey protein. The ratio may be reduced for example by using such techniques as microfiltration or enhanced by the addition of un-denatured whey protein concentrate (WPC). Suitable WPCs are available commercially. Examples of materials that may be used in the dairy starting material may be selected from one or more of skim milk, whole milk, casein, caseinate, milk protein concentrate/retenate and whey protein concentrate/retentate. The term “dairy starting material” does not include materials which have undergone calcium removal steps for example using cation-exchange chromatography.

Preferably the invention applies to a dairy stream that has been ultrafiltered to increase the protein concentration relative to the lactose concentration. Ultrafiltration (UF) for this purpose is well known in the art of dairy processing. The protein-enriched stream from the UF treatment is the retentate.

The pH adjustment-heat treatment steps may be conducted at any stage on the dairy stream prior to drying. Preferably the pH adjustment-heat treatment is performed using a retentate stream and after it has been concentrated and prior to spray drying.

The dried product may be used, when and where as desired, as an ingredient in the preparation of milk protein gels. Such gels may or may not contain emulsifying salts. PC and PC-like products are products (including processed cheese spreads) prepared historically by melting cheese, along with other ingredients, to produce a smooth homogenous product.

### Definition of Denaturation

Denaturation refers to the extent of the reactions involving the whey protein (specifically β-lactoglobulin) in conjunction with the casein present in the dairy stream. Without being bound by theory, the heat and pH mediated interaction between the dairy proteins is complex. A measure of the extent of the interaction involving the whey protein is the native polyacrylamide gel electrophoresis (native-PAGE) method described by Anema & Lloyd in Analysis of whey protein denaturation: a comparative study of alternative methods. Anema S. G. & Lloyd R. J. Milchwissenschaft, 54 (1999) pp 206-210.

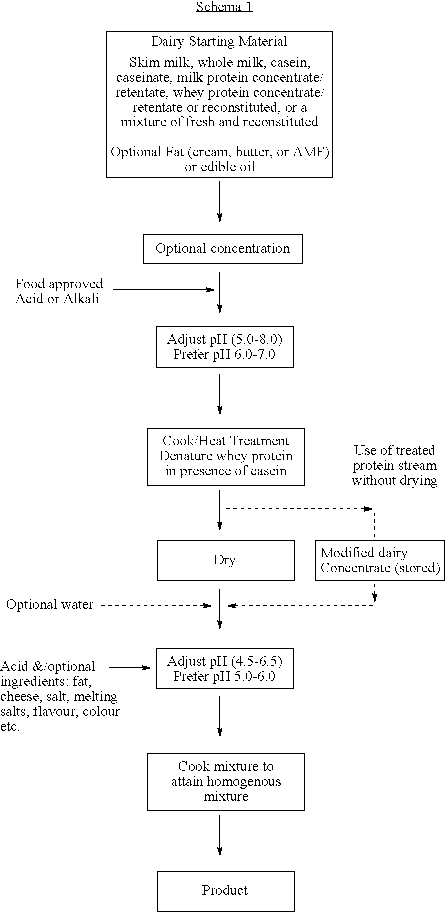

Scheme 1 shows a flow diagram of the preferred process.

A dairy stream containing casein and whey protein may be prepared using milk or skim milk or prepared by using reconstituted milk powder, preferably low-heat milk powder. The dairy stream may also be prepared by combining a casein rich stream with a whey protein rich stream. Either may be prepared using reconstitution methods. The ratio of whey protein to casein may be varied within the range of 0.05 to 3, preferably 0.1 to 0.75.

Preferably the dairy stream is a concentrated source of casein and whey protein. Such a concentrated dairy stream may be attained by evaporation or ultrafiltration, or a combination of both, or microfilration, or combinations of the three. A concentrated dairy stream may be prepared by adding dry ingredients to a liquid stream. Preferably the solids not fat, expressed on a fat-free basis, is between 10% and 60%, more preferably between 10% and 60%, most preferably between 20% and 55%.

The preferred pH of the concentrated dairy stream prior to heat treatment is between 5.0 and 8.0, more preferably 6.0<pH<7.5 and most preferably 6.2<pH<7.2. A pH in the range 6.8-7.2 is particularly useful where an increase in viscosity is sought. Any convenient acid or base may be used to adjust the pH. Dilute hydrochloric acid or a caustic soda solution is suitable depending on the pH shift required. Preferably acid or alkali is added to adjust the pH to a target pH in the range which facilitates preparation of milk protein gels of the desired texture.

Following the adjustment of the pH, the dairy stream is heated to induce reactions that involve the proteins. Specifically the whey protein is denatured in the presence of casein using heat. The desired level of denaturation is between 40 and 100%, preferably at least 60% and most preferably at least 80%. At least 80% denaturation can be achieved by heating the concentrated dairy stream (at the desired pH) to 90° C. for about 4 minutes. Alternative time-temperature combinations that achieve an equivalent level of denaturation may be used.

In one embodiment the heat-treated dairy stream is spray dried to a moisture content that results in an ambient storage stable powder. In a preferred embodiment, the dry ingredient is a modified milk protein concentrate (MPC).

In an alternative embodiment the heat-treated dairy stream may be used directly as an ingredient in the manufacture of milk protein gels.

In another aspect the invention provides a method for preparing a milk protein containing gel comprising:
(a) dissolving/suspending a powder as described above in an aqueous liquid
(b) Adding acid to adjust the pH to be in the range 4.5-6.5.
(c) Cooking the mixture to form a molten mass.
(d) Cooling the molten mass to form a milk protein gel,
   wherein step (b) may be carried out before, during or after step (c).

In yet a further method the invention provides a method for preparing a milk protein gel comprising
(a) providing a dairy concentrate as described above;
(b) adding acid to adjust the pH to be in the range 4.5-6.5;
(c) cooking the mixture to form a molten mass;
(d) cooling the molten mass to form a milk protein gel;
wherein step (b) may be carried out before, during or after step (c).

The ingredient (either the powder or the liquid dairy concentrate) may be used in the preparation of a milk protein gel. The powder is dissolved/suspended in an aqueous liquid. The liquid dairy concentrate may be used as prepared.

At this stage the ingredient may be used along with acid and optional ingredients such as a solvent, edible fat, cheese, carbohydrate, salt, emulsifying salts, flavouring etc to produce a mixture. Sufficient acid is added to adjust the pH to a pH in the range 4.5-6.5, preferably 5.0-6.0. The mixture is cooked with agitation using shear to produce a homogenous molten mass. Upon cooking the mass is poured into a suitable packaging system to attain the desired product. Preferred cooking temperatures are in the range 50° C. and up to the boiling point of the mixture. Particularly preferred temperatures are in the range 72° C. to 90° C. Cooking times may be from 1 second up to about 20 minutes. Ingredients such as a solvent, edible fat, cheese, carbohydrate, salt emulsifying salts, flavouring etc may also be added during cooking.

The constituents are varied according to the nature of the desired product. For example for a processed cheese high amounts of protein are used with a fat content reflecting the desired cheese type. For a spread the fat content would generally be increased. For a yoghurt a stronger acidulant and more water would be used and protein and fat content would be decreased. For a dairy dessert, sugar or another sweetener would be included with an appropriate dessert flavouring and increased amounts of water relative to fat and protein.

### BRIEF DESCRIPTION OF THE DRAWINGS

FIG. 1 shows the relationship between texture (G′) and extent of pH-adjusted denaturation of the whey proteins from Tables 2 & 3.

### EXAMPLES

The following examples further illustrate practice of the invention.

### Example 1

### Methods for Making Processed Cheese Spreads Using Pre-Treated Retentate

Processed Cheese Prepared from Reconstituted MPC 70

### A. Reconstitution and Heating Procedure

ALAPRO 4700 [MPC70] (Fonterra Co-operative Group Limited, Auckland) was reconstituted to 22% solids, 16% protein using RO water. The water was pre-warmed to 50° C. in a water bath. The MPC powder was added to the warm water and the mixture was stirred at 50° C. for 30 min. After this, the retentate solution was cooled to room temperature in cold water and held for 2.5 hours. The prepared retentate was divided into seven sub-samples.

Samples of the retentate were pH adjusted using 1M NaOH or 1M HCl. Each sub-sample was pH adjusted according to one of the values in the series: +0.6, +0.4, +0.2, 0 (Control), −0.2, −0.4, and −0.6 pH units from the natural pH of the retentate 6.64. The pH adjusted sub-samples were allowed to equilibrate for about 2 hr with periodic checking and minor readjustment of the pH.

For each pH adjusted retentate, five samples were prepared. 600 g of each sample was weighed into a pair of Schott bottles (300 g in each bottle) and then heated to 65° C. in a 65° C. water bath. (The splitting of the samples was carried out to facilitate the subsequent heat treatment step.) The pre-warmed samples were transferred to a water bath set at 85° C. and heated for the prescribed time (0, 4, 6, 8 and 14 min). (This gave 7 pH×5 heat treatments.) After heating, the samples were then transferred to an ice bath, shaken to rapidly cool the samples to a temperature below 70° C. After cooling, the samples were transferred to a refrigerator (set at 4° C.) until their use in processed cheese manufacture (Section B) on the following day.

### B. Processed Cheese Spread Formulation

The pH and heat-treated samples of retentate from section A were used to produce processed cheese spreads using the following formulation.

Formulation

| Ingredient | Weight (g) |
|---|---|
| Soya oil | 185.0 |
| pH & heat treated retentate | 360.0 |
| Water | 17.5 (includes allowance of |
| | 7.5 g for evaporation) |
| Sodium chloride | 6.0 |
| Tri-sodium citrate•2H₂O | (15-X) g (see Table 1) |
| Citric acid (anhyd.) | X g (see Table 1) |
| Total | 583.5 g |

TABLE 1
Values of quantity of salts to attain final product pH of 5.75

| pH of the retentate sample | X |
|---|---|
| 6.04 (−0.6) | 2.498 |
| 6.24 (−0.4) | 2.764 |
| 6.44 (−0.2) | 2.965 |
| 6.64 (0) | 3.20 |
| 6.84 (+0.2) | 3.29 |
| 7.04 (+0.4) | 3.40 |
| 7.24 (+0.6) | 3.605 |

### C. Processed Cheese Spread Preparation Method

The processed cheese spread samples were prepared using a 2 L capacity Vorwerk Thermomix™ 21 blender cooker (Vorwerk Australia Pty. Ltd., Granville, N.S.W., Australia).

Soya oil (AMCO, Goodman Fielder, East Tamaki, New Zealand) was heated at a temperature setting of 100 and speed setting of 1, which brought the temperature of the oil to about 60° C. in 1 minute.

For the control sample (no pH adjustment), 360 g retentate from A, 11.8 g (i.e. 15 g-3.20 g from Table 1) tri-sodium citrate.2H₂O (Jungbunzlauer GmbH, Perhofen, Austria), 3.20 g citric acid (from Table 1) (Jungbunzlauer GmbH, Perhofen, Austria), 6.0 g sodium chloride (Pacific salt, Christchurch, New Zealand) and 17.5 g water were added to the pre-heated oil.

The mixture was heated at a temperature setting of 90 in the cooker (approximately 90° C.) for 2 min at speed 4 (2000 rpm), after which the temperature was lowered to a temperature setting of 80 (approximately 80° C.) for 7 min. At the end of each minute, the speed was set to “Turbo” for 3 s to thoroughly mix the emulsion as well as to prevent burning and sticking of the emulsion to the wall of the cooker. The molten processed cheese was poured into plastic screwed cap containers, inverted then stored at 4° C. The final pH of the processed cheese was 5.75.

This same procedure was repeated for the pH-adjusted-heat treated samples.

### D. Composition of the Processed Cheese Spreads

The processed cheese had 51.8% moisture, 32.1% fat, 10.0% protein, 2.5% lactose and remainder 3.6% minerals (including other minor components).

### Analysis of Texture

The texture of the samples was measured as elastic modulus (G′) at 0.1 Hz at 20° C. using a Carri-Med CSL100 rheometer (TA Instruments—Waters LLC, New Castle, USA) instrument. The G′ values are shown in Table 2.

TABLE 2
Firmness (G′)of spread samples

| | |
|---|---|
| | G′ (Pa) for heat treatment (minutes in 85° C. |
| pH | water bath) of retentate |

| treatment | 0 | 4 | 6 | 8 | 14 |
|---|---|---|---|---|---|
| 6.04 | 141 | 181 | 148 | 171 | 205 |
| 6.24 | 127 | 144 | 199 | 243 | 263 |
| 6.44 | 103 | 190 | 255 | 316 | 321 |
| 6.64 | 101 (Control) | 228 | 356 | 434 | 554 |
| 6.84 | 115 | 199 | 316 | 445 | 613 |
| 7.04 | 152 | 297 | 449 | 472 | 517 |
| 7.24 | 165 | 387 | 492 | 588 | 697 |

The level of whey protein denaturation was assessed using polyacrylamide gel electrophoresis, as described below. Table 3 shows the levels of denaturation in the retentate after the pH-adjusted heat treatment.

TABLE 3
Percentage denaturation in treated retentates

| | Denaturation (%) after heat treatment (minutes in 85° C. | | | | |
|---|---|---|---|---|---|
| pH | water bath) of retentate | | | | |
| treatment | 0 | 4 | 6 | 8 | 14 |
| 6.04 | 0 | 4.7 | 21.1 | 54.5 | 84.6 |
| 6.24 | 0 | 15.0 | 50.3 | 67.4 | 83.9 |
| 6.44 | 0 | 24.5 | 54.0 | 73.6 | 94.8 |
| 6.64 | 0 (Control) | 36.8 | 58.8 | 79.5 | 95.8 |
| 6.84 | 0 | 29.6 | 65.3 | 81.4 | 95.8 |
| 7.04 | 0 | 45.4 | 75.1 | 84.0 | 92.4 |
| 7.24 | 0 | 58.6 | 75.9 | 89.3 | 96.9 |

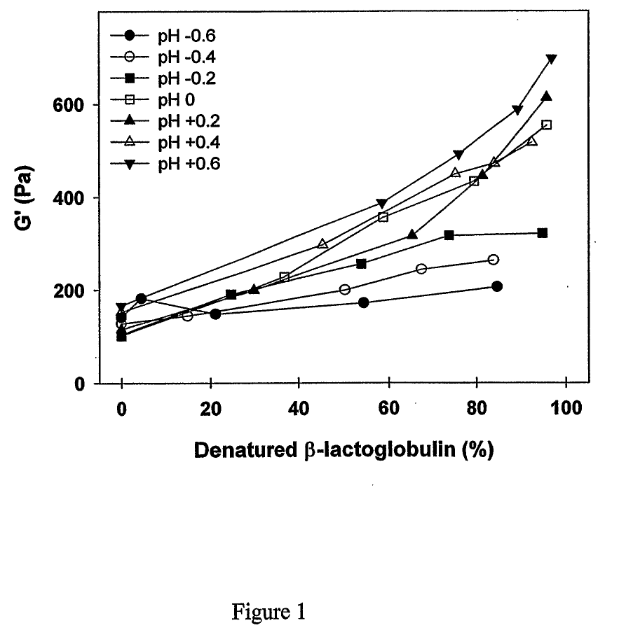

FIG. 1 shows the relationship between texture (G′) and extent of pH-adjusted denaturation of the whey proteins from Tables 2 & 3.

These experiments showed that a milk protein ingredient containing both casein and whey protein, if given a combined pH adjustment and heat treatment of this invention, could be used to subsequently modify the texture of a processed cheese-like product or other milk protein gel. Higher viscosities were obtained with increasing pH and percentage denaturation.

Processed Cheese Manufacture and Heating from Fresh Retentate:

A second series of experiments were performed to show that a pH adjusted and heat treated ingredient could be prepared from a fresh milk protein source and which could be subsequently dried and then used to modify the texture of a cheese-like product.

### A. Manufacture of pH Adjusted and Heat-Treated MPC70 Powders

Fifteen hundred litres of skim milk retentate containing 73% protein (on dry basis) and total solids content of about 21% was sourced from the Fonterra Whareroa site. This retentate was diluted at 1:1 ratio with demineralised water to make about 3000 L. The diluted retentate, which had a pH of about 6.95, was divided into four parts of about 750 L. The first portion (Control 1) was evaporated as is without any pH manipulation or pre-heat treatment using a 3-effect Wiegand evaporator to a solids content of about 30% and dried in a De Laval drier to produce a control non-heat-treated MPC70 powder (approximately 3% moisture). The same evaporator and driers were used for making powders from the other three streams. The second stream (without pH adjustment [Control 2]) was heat treated at 90° C. for 240 seconds prior to evaporation and drying to produce a heat-treated control MPC70 powder. The third stream was pH adjusted to 7.15 using 10% NaOH solution. This stream was again heat treated at 90° C. for 240 seconds to produce high-pH heat-treated MPC70 powder. The last stream was pH adjusted to 6.59 using 3% sulphuric acid. The resulting low pH retentate was heat treated at 90° C. for 240 seconds to produce low-pH-heat-treated MPC70 powder.

### B. Processed Cheese Spread Making Formulation

Formulation

| Ingredient | Weight (g) |
|---|---|
| Soya oil | 185.0 |
| Dried ingredient of this invention | 82.7 |
| Water | 280.5 (with allowance of |
| | 7.5 g for evaporation) |
| Sodium chloride | 6.0 |
| Tri-sodium citrate•2H₂O | (15-X) g (see Table 4) |
| Citric acid (anhyd.) | X g (see Table 4) |
| Total | 561.7 g |

TABLE 4
Values of quantity of salts to attain final product pH of 5.75

| pH of the retentate sample selected | X |
|---|---|
| −0.3 (pH 6.65) | 2.859 |
| 0 (Control 1 & Control 2) [pH 6.95] | 3.337 |
| +0.3 (pH 7.25) | 3.555 |

### C. Processed Cheese Spread Preparation Method

The model processed cheese spreads were prepared using a 2 L capacity Vorwerk Thermomix™ 21 blender cooker (Vorwerk Australia Pty. Ltd., Granville, N.S.W., Australia).

For the non-pH adjusted samples control 1 & 2, 82.5 g of MPC 70 (prepared as described above) was hydrated in 230 g of water and left overnight in a refrigerator (4° C.).

Soya oil (AMCO, Goodman Fielder, East Tamaki,) was heated for 1 min at temperature setting of 100 and speed setting at 1 (this increased the temperature of the oil to about 60° C.).

To the hydrated MPC 70, 11.663 g tri-sodium citrate.2H₂O (Jungbunzlauer GmbH, Perhofen, Austria), 3.337 g citric acid (Jungbunzlauer GmbH, Perhofen, Austria), 6.0 g sodium chloride (Pacific salt, Christchurch, New Zealand) and 50.5 g water were added to the pre-heated oil.

The mixture was cooked at a temperature setting of 90 (about 90° C.) for 2 min at speed 4 (2000 rpm), after which the temperature was lowered to a temperature setting of 80 (about 80° C.) for 7 min. At the end of each minute, the speed was set to “Turbo” for 3 s to thoroughly mix the emulsion as well to prevent burning and sticking of the emulsion to the wall of the cooker. The molten processed cheese was poured into plastic screwed cap containers, inverted then stored at 4° C. The final pH of the processed cheese was 5.75.

This same method was also used for the heated and pH-adjusted ingredients.

### D. Composition of the Processed Cheese Spreads

The processed cheese had 50.2% moisture, 33.1% fat, 10.4% protein, 2.6% lactose and remainder 3.7% minerals and other minor components.

### Analysis of Texture

The texture of the processed cheese samples was determined as above and the texture results are shown in Table 5.

The level of whey protein denaturation was assessed using polyacrylamide gel electrophoresis, as described below. Table 5 shows the levels of denaturation in the prepared powder.

TABLE 5
Texture (G′) of processed cheese samples

| | Control 1 | | Control 2 | |
|---|---|---|---|---|
| | (unheated, | | (heated, | |
| Treatment | pH 6.95) | pH 6.5 + heat | pH 6.95) | pH 7.1 + heat |
| Texture G′ | 300 | 291 | 665 | 913 |
| (Pa) | | | | |
| Denaturation | 0 | 81.7 | 91.4 | 90.7 |
| in powder (%) | | | | |

The results in Table 5 confirmed that the texture of cheese-like products prepared using the pH adjusted and heat-treated dried ingredient were modified on a similar basis to the principles demonstrated in Table 2.

### Method Used to Determine Extent of Protein Denaturation for Retentate/MPC Samples—Modified Polyacrylamide Gel Electrophoresis (PAGE) Analysis Method

The level of whey protein denaturation as a consequence of heating the reconstituted and fresh MPC samples was monitored by native polyacrylamide gel electrophoresis (native-PAGE). The method for native PAGE is similar to that described by Anema & Lloyd (Milchwissenschaft, 1999, 54, pp 206-210) and Anema & McKenna (J. Ag. Food Chem., 1996, 44, 422-428) with the following modifications:

1. Retentate (22% total solids) was diluted 1:100 with native PAGE sample buffer;
2. Gels were stained with 100 ml of Amido Black (1% Amido Black in 10% acetic acid and 25% iso-propanol) for at least 1 hr;
3. Gels were de-stained with several changes of 100 ml of 10% acetic acid solution until a clear background was achieved;
4. The gels were scanned on a Molecular Dynamic Model P.D densitometer and integrated using the Molecular Dynamics Imagequant software associated with the densitometer (both Molecular Dynamics, Sunnyvale, Calif., USA).

The level of whey protein denaturation in the heated MPC samples was assessed by monitoring the level of denaturation of β-lactoglobulin, as this protein is the major whey protein in MPC and milk samples, and its level of denaturation is known to be correlated with total whey protein denaturation, as assessed by other methods commonly used for monitoring the level of whey protein denaturation (Anema & Lloyd, Milchwissenschaft, 1999, 54, pp 206-210). The intensity of the β-lactoglobulin bands in the heated samples were measured as a percentage of that in the unheated control.

The term “comprising” means “consisting of” or “including”. The processes of the invention may have additional steps and ingredients for example salt, flavouring, colouring etc may be added.

The above examples are illustrations of the practice of the invention. It will be appreciated by those skilled in the art that the invention can be carried out with numerous modifications and variations. For example the casein/whey ratio, the cooking temperature the cooking pH and acid used to alter the pH may all be varied.

1. A method for producing a dairy powder comprising:
(a) providing liquid dairy starting material comprising casein and whey proteins and having a solids not fat content, expressed on a fat free basis, of between 10% (w/w) and 60% (w/w);
(b) adjusting if necessary the pH by addition of acid or alkali to a pH in the range 5.0-8.0;
(c) heat-treating the pH adjusted material to denature whey protein in the presence of casein; and
(d) drying the heat-treated material to form a powder.

2. (canceled)

3. (canceled)

4. (canceled)

5. (canceled)

6. A method as claimed in claim 1 wherein the dairy starting material comprises at least one of: skim milk, whole milk, casein, caseinate, milk protein concentrate/retenate and whey protein concentrate/retentate.

7. (canceled)

8. (canceled)

9. A method as claimed in claim 1 wherein the pH is adjusted if necessary to a pH in the range 6.2 to 7.2 in step (b).

10. A method as claimed in claim 9 wherein the pH is adjusted to a pH in the range 6.8-7.2.

11. (canceled)

12. A method as claimed in claim 1 wherein after the heat treatment over 60% of the whey protein is denatured.

13. (canceled)

14. (canceled)

15. (canceled)

16. A method for preparing a milk protein gel comprising
(a) Dissolving/suspending a dairy powder comprising casein and whey proteins in a aqueous liquid;
(b) Adding acid to adjust the pH to be in the range 4.5-6.5;
(c) Cooking the mixture to form a molten mass;
(d) Cooling the molten mass to form a milk protein gel,
wherein step (b) may be carried out before, during or after step (c) and wherein the dairy powder is prepared from a dairy liquid heat-treated at a pH in the range of 5.0-8.0.

17. A method as claimed in claim 16 wherein the product is selected from a processed cheese, a processed cheese-like product, a spread, or a dairy dessert.

18. A method as claimed in claim 16 wherein the pH is adjusted to pH 5.0-6.0 in step (b).

19. A method as claimed in claim 16 wherein the cooking step is carried out at between 50° C. and up to the boiling point of the mixture.

20. A method as claimed in claim 19 wherein the cooking temperature is in the range 72° C.-90° C.

21. A method as claimed in claim 16 wherein the cooking step has a duration of between 1 second and 20 minutes.

22. A method as claimed in claim 16 wherein the cooling step takes place in packaging for the product.

23. A method as claimed in claim 16 wherein the powder has a whey protein to casein ratio in the range of 0.05 to 3.

24. A method as claimed in claim 23 wherein the ratio is in the range of 0.1 to 0.75.

25. A method as claimed in claim 16 wherein the dairy powder was prepared from at least one of: skim milk, whole milk, casein, caseinate, milk protein concentrate/retentate and whey protein concentrate/retentate.

26. A method as claimed in claim 25 wherein prior to or during the cooking step, at least one ingredient selected from the following group is added to the mixture: fat, cheese, salt, melting salts, flavouring agents and colouring agents.

27. A method as claimed in claim 26 wherein the powder was prepared from a pH adjusted dairy starting material having a pH in the range 6.0 to 7.5.

28. A method as claimed in claim 27 wherein the powder was prepared from a pH adjusted dairy starting material having a pH in the range 6.2 to 7.2.

29. A method as claimed in claim 28 wherein over 60% of the whey protein in the powder is denatured.

30. A method as claimed in claim 29 wherein over 80% of the whey protein in the powder is denatured.

31. A method as claimed in claim 30 wherein the powder is a spray dried powder.

32. A method for producing a dairy concentrate comprising:
(a) providing liquid dairy starting material comprising casein and whey proteins;
(b) concentrating the material if necessary to give a solids not fat content of greater than 10% (w/w);
(c) adjusting if necessary the pH by addition of acid or alkali to a pH in the range 5.0-8.0;
(d) heat-treating the pH adjusted material to denature whey protein in the presence of casein; and
(e) cooling the heat-treated material and storing it in one or more storage vessels.
wherein step (b) may be carried out before, during or after step (c).

33. (canceled)

34. (canceled)

35. (canceled)

36. (canceled)

37. A method as claimed in claim 32 wherein the dairy starting material comprises at least one of: skim milk, whole milk, casein, caseinate, milk protein concentrate/retentate and whey protein concentrate/retentate.

38. A method as claimed in claim 32 wherein the material to be heat-treated has a solids not fat content, expressed on a fat free basis of between 5% and 60%.

39. A method as claimed in claim 32 wherein the pH is adjusted if necessary to a pH in the range 6.0 to 7.5 in step (c).

40. A method as claimed in claim 39 wherein the pH is adjusted if necessary to a pH in the range 6.2 to 7.2.

41. A method as claimed in claim 40 wherein the pH is adjusted to a pH in the range 6.8-7.2.

42. (canceled)

43. A method as claimed in claim 32 wherein after the heat treatment over 60% of the whey protein is denatured.

44. (canceled)

45. (canceled)

46. A method for preparing a milk protein gel comprising:
(a) providing a dairy concentrate as prepared by the method of claim 32;
(b) adding acid to adjust the pH to be in the range 4.5-6.5;
(c) cooking the mixture to form a molten mass;
(d) cooling the molten mass to form a milk protein gel;
wherein step (b) may be carried out before, during or after step (c).

47. A method as claimed in claim 46 wherein the product is selected from a processed cheese, a processed cheese-like product, a spread, or a dairy dessert.

48. A method as claimed in claim 46 wherein the pH is adjusted to pH 5.0-6.0 in step (b).

49. A method as claimed in claim 46 wherein the cooking step is carried out at between 50° C. and up to the boiling point of the mixture.

50. A method as claimed in claim 49 wherein the cooking temperature is in the range 72° C.-90° C.

51. A method as claimed in claim 46 wherein the cooking step has a duration of between 1 second and 20 minutes.

52. A method as claimed in claim 46 wherein the cooling step takes place in packaging for the product.

53. A method as claimed in claim 46 wherein the dairy concentrate has a whey protein to casein ratio in the range of 0.05 to 3.

54. A method as claimed in claim 53 wherein the ratio is in the range of 0.1 to 0.75.

55. A method as claimed in claim 46 wherein the dairy concentrate was prepared from at least one of: skim milk, whole milk, casein, caseinate, milk protein concentrate/retentate and whey protein concentrate/retentate.

56. A method as claimed in claim 46 wherein prior to the cooking step at least one ingredient selected from the following group is added to the mixture: fat, cheese, salt, melting salts, flavouring agents and colouring agents.

57. A method as claimed in claim 46 wherein the dairy concentrate is prepared from a pH adjusted dairy starting material having a pH in the range 6.0 to 7.5.

58. A method as claimed in claim 57 wherein the dairy concentrate is prepared from a pH adjusted dairy starting material having a pH in the range 6.2 to 7.

59. A method as claimed in claim 46 wherein over 60% of the whey protein in the dairy concentrate is denatured.

60. A method as claimed in claim 59 wherein over 80% of the whey protein in the dairy concentrate is denatured.
